(19) United States
(12) Patent Application Publication
(10) Pub. No.: US 2020/0004706 A1
(43) Pub. Date: Jan. 2, 2020

(54) INFORMATION PROCESSING DEVICE AND INFORMATION PROCESSING METHOD

(71) Applicant: NIDEC SANKYO CORPORATION, Nagano (JP)

(72) Inventor: Tsutomu BABA, Nagano (JP)

(21) Appl. No.: 16/454,620

(22) Filed: Jun. 27, 2019

(30) Foreign Application Priority Data
Jun. 29, 2018 (JP) 2018-124591

(51) Int. Cl. G06F 13/20; G06F 21/60; H04L 9/32; G06K 7/08

(52) U.S. Cl. CPC G06F 13/20; G06K 7/087; H04L 9/3234; G06F 21/602

(57) ABSTRACT

An information processing device may include a master device and a slave device capable of communicating with each other. The master device may include a state notification part performing a state notification to the slave device corresponding to a state change, and a command transmission part which waits restoration of the state change and, when restored, transmits the command to the slave device for making execute processing corresponding to the state change. The slave device may include a state notification detection part which sets a notification detection flag when the state notification from the master device is detected, and a state processing execution part which waits the command from the master device and, when the command is received, in a case that the notification detection flag has been set, the state processing execution part performs the processing corresponding to the state change.

### CROSS REFERENCE TO RELATED APPLICATION

The present invention claims priority under 35 U.S.C. § 119 to Japanese Application No. 2018-124591 filed Jun. 29, 2018, the entire content of which is incorporated herein by reference.

### TECHNICAL FIELD

At least an embodiment of the present invention may relate to an information processing device and an information processing method, and especially, to an information processing device and an information processing method in which a master device and a slave device are capable of communicating with each other.

### BACKGROUND

Conventionally, there is an information processing device such as a card reader in which a master device and a slave device are capable of communicating with each other. For example, in Patent Literature 1 (Japanese Patent Laid-Open No. 2014-67230), an information processing device is described which includes a master device and a slave device connected with each other through two kinds of signal lines, i.e., a clock signal line and a data signal line, and data are transmitted by a predetermined communication system.

In such an information processing device, when a master device notifies a state change to a slave device, the master device transmits a state notification command from the master device through a communication line. The slave device receives this command, recognizes the state change of the master device, and executes necessary processing.

However, in the conventional information processing device as described in Patent Literature 1, when a state change such as voltage reduction is occurred, communication becomes unstable and, as a result, the state change is unable to be notified from the master device to the slave device. In this case, when the state change is restored, even when the master device instructs the slave device to execute processing corresponding to the state change, the above-mentioned necessary processing has not been executed and thus, an error may occur.

### SUMMARY

In view of the problems described above, at least an embodiment of the present invention may advantageously provide an information processing device in which the slave device is capable of surely executing processing corresponding to a state change.

According to at least an embodiment of the present invention, there may be provided an information processing device including a master device and a slave device which are capable of communicating with each other, a state notification line connected between the master device and the slave device for performing a state notification of the master device, and a communication line connected between the master device and the slave device for transmitting and receiving a command and data. The master device includes a state notification part which performs the state notification to the slave device through the state notification line corresponding to a state change, and a command transmission part which waits restoration from the state change and, when the state change is restored, transmits the command to the slave device for making execute processing corresponding to the state change through the communication line. The slave device includes a state notification detection part which sets a notification detection flag when the state notification detection part detects the state notification from the master device through the state notification line, and a state processing execution part which waits the command from the master device without immediately executing processing corresponding to the state change when the state notification detection part detects the state notification and, when the state processing execution part receives the command, in a case that the notification detection flag has been set, the state processing execution part performs the processing corresponding to the state change and, in a case that the notification detection flag is not set, the state processing execution part does not perform the processing corresponding to the state change. According to this structure, processing corresponding to the state change can be executed surely in the slave device.

In the information processing device in at least an embodiment of the present invention, the master device is a main processing device which monitors a state of a card medium detection sensor and controls various drive mechanisms, and the slave device is a sub-processing device which executes encryption of information, processes encrypted information, and controls writing and reading of information to and from a card medium. According to this structure, in the slave device which is required to observe a specific processing procedure for performing encryption processing, processing corresponding to the state change can be surely executed.

In the information processing device in at least an embodiment of the present invention, the state notification is a notification of the state of a voltage reduction and, when the voltage reduction is occurred, the state processing execution part executes processing which clears a sequence of processing of the information. According to this structure, when power supply is restored, after the command is received, the sequence can be cleared to prepare transaction resumption.

In the information processing device in at least an embodiment of the present invention, the information processing device is a card reader. According to this structure, a card reader can be provided which is capable of surely executing processing corresponding to the state change.

According to at least an embodiment of the present invention, there may be provided an information processing method executed by an information processing device which includes a master device and a slave device capable of communicating with each other, a state notification line connected between the master device and the slave device for performing a state notification of the master device, and a communication line connected between the master device and the slave device for transmitting and receiving a command and data. The information processing method includes performing the state notification by the master device to the slave device through the state notification line corresponding to a state change, setting a notification detection flag when the slave device detects the state notification from the master device through the state notification line, waiting the command from the master device without immediately executing processing corresponding to the state change when the state notification is detected by the slave device, waiting restoration from the state change in the master device and, when the state change is restored, transmitting the command by the master device to the slave device for making execute processing corresponding to the state change and, when the slave device receives the command, in a case that the notification detection flag has been set, the processing corresponding to the state change is performed and, in a case that the notification detection flag is not set, the processing corresponding to the state change is not performed. According to this structure, processing corresponding to the state change can be executed surely.

### Effects of the Invention

According to at least an embodiment of the present invention, a state notification is performed from the master device to the slave device through the state notification line corresponding to a state change and, when the slave device detects the state notification, the slave device further waits a command from the master device without immediately executing processing corresponding to the state change and, in a case that the slave device receives the command, the slave device performs processing corresponding to the state change. Therefore, the information processing device can be provided in which the slave device is capable of surely executing processing corresponding to the state change.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a system configuration diagram of an information processing system “X” in accordance with an embodiment of the present invention.

FIG. 2 is a flow chart of state recognition corresponding processing in accordance with an embodiment of the present invention.

FIG. 3A through FIG. 3C are concept diagrams of the state recognition corresponding processing shown in FIG. 2.

FIG. 4A through FIG. 4C are concept diagrams of the state recognition corresponding processing shown in FIG. 2.

FIG. 5A and FIG. 5B are concept diagrams of the state recognition corresponding processing shown in FIG. 2.

### DETAILED DESCRIPTION

### Embodiments

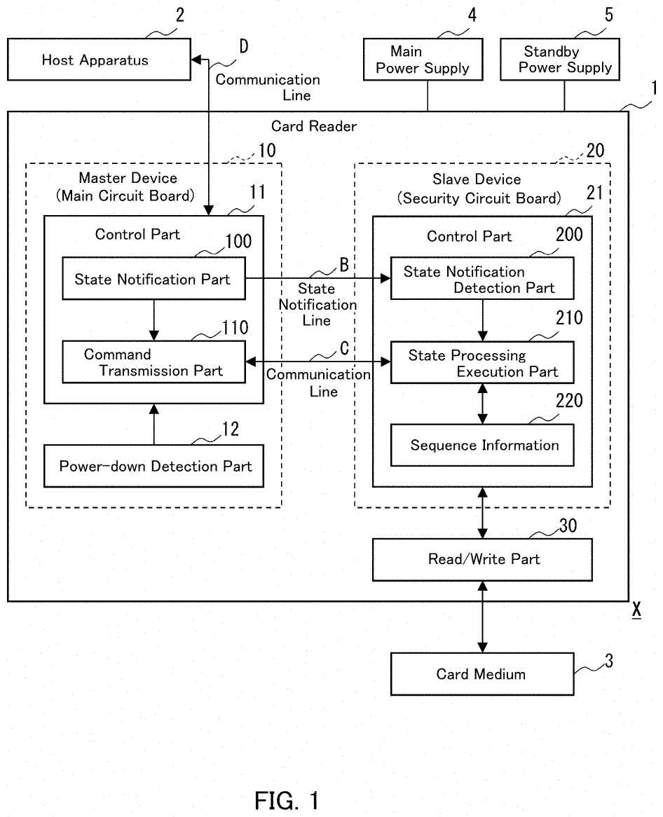

A configuration of an information processing system “X” in accordance with at least an embodiment of the present invention will be described below with reference to FIG. 1. In this embodiment, an information processing system “X” includes an ATM (Automated Teller Machine) provided with a card issue function, a terminal of a kiosk, a ticket issue system of transportation, a point card issue system of a convenience store or the like, a member card issue system of a retail store, a card issue/payment system of a game machine, an entrance/exit management system or the like (hereinafter, simply referred to as “ATM or the like”).

The information processing system “X” includes a card reader 1, a host apparatus 2, a main power supply 4 and a standby power supply 5.

The card reader 1 is a device capable of reading from or writing in a card medium 3 which is a contact type or a non-contact type IC card and/or a magnetic card provided with a magnetic stripe. The card reader 1 is an example of an information processing device in this embodiment. A detailed structure of the card reader 1 will be described below.

The host apparatus 2 is a main apparatus for realizing respective functions of an ATM or the like. Specifically, the host apparatus 2 includes, for example, a control calculation device such as a PC (Personal Computer), a tablet terminal or a cellular phone for controlling respective parts, and executes applications (Application Program, not shown) for realizing functions of the information processing system “X”. In addition, the host apparatus 2 is connected with peripheral devices such as a printer for printing or marking on a surface of a card medium 3, a display such as an LCD panel or an organic EL panel, a touch panel and buttons.

The card reader 1 and the host apparatus 2 are connected with each other through a communication line “D”. The communication line “D” is, for example, a general-purpose bus, serial, parallel, IP network or the like. Information including various instructions (command) and data can be transmitted and received through the communication line “D”.

The main power supply 4 is a power supply circuit which is connected with an electric lamp line or the like. The main power supply 4 is provided with a buffer function in which an output is not lost immediately even when power of the electric lamp line or the like is interrupted or reduced to some extent, and a voltage is reduced at a specific rate during a specific time period.

The standby power supply 5 is a standby power supply which is connected separately from the main power supply 4. The standby power supply 5 is, for example, various batteries and capacitors, an uninterruptible power supply device, an emergency power generator and the like. When a voltage of the main power supply 4 is reduced to a predetermined voltage or lower and the low-voltage state is continued, the standby power supply 5 supplies power supply before functions of the master device 10 and the slave device 20 are stopped due to power interruption.

More specifically, the card reader 1 is an information processing device including a master device 10, a slave device 20, and a read/write part 30. A state notification line “B” and a communication line “C” are connected between the master device 10 and the slave device 20.

The master device 10 is a main processing device structured to perform general processing as the card reader 1 and monitoring of a state of a detection sensor for a card medium 3 and to control various drive mechanisms. The master device 10 is, for example, configured as various circuits on a main circuit board for controlling the entire card reader 1. In this embodiment, the master device 10 controls the slave device 20 connected with the master device 10 through communication.

The slave device 20 is a sub-processing device in which a security function for executing encryption of information or processing the encrypted information is realized, or writing and reading of information to and from a card medium 3 are controlled. The slave device 20 is, for example, configured as various circuits on a security circuit board which is connected with the master device 10. In this embodiment, the slave device 20 is configured in accordance with PCI (Payment Card Industry) standard to realize a security function of the card reader 1. Therefore, the slave device 20 is, for example, provided with a data encryption function, a decryption function, an illegal modification detection function of the card reader 1, and the like for preventing a swindle of data such as an ID, a personal identification number, and a password stored in a card medium 3. In addition, the slave device 20 in this embodiment is configured so as not to execute processing unless the slave device 20 is controlled in compliance with specific processing procedure for security.

The read/write part 30 is a configuration part including a magnetic head, an electromagnetic induction coil, terminals and the like for performing reading from and writing to a card medium 3, and circuits for performing the processing.

The state notification line “B” is a signal line which outputs a logic for performing monitoring of a state. The state notification line “B” is, for example, provided as one of pins of GPIO (General-purpose input/output). In this case, the state notification line “B” notifies the state from the master device 10 to the slave device 20 by inversion of the logic. Monitoring of a logic change of the state notification line “B” can be processed by reading and writing of a control register and thus, notification can be performed at a higher speed than transmission of a command through the communication line “C” and can be also coped with sudden voltage reduction, and influence on other processing is also reduced. Further, regarding monitoring of the logic change, an interrupt may be set.

The communication line “C” is, for example, a signal line such as a general-purpose bus, serial or parallel. The communication line “C” is capable of transmitting and receiving information including various instructions (command) and data between the master device 10 and the slave device 20.

More specifically, the master device 10 includes a control part 11 and a power-down detection part 12. The slave device 20 includes a control part 21.

The control part 11 is a control calculation means such as a CPU (Central Processing Unit), MPU (Micro Processing Unit), GPU (Graphics Processing Unit), DSP (Digital Signal Processor) or ASIC (Application Specific Integrated Circuit) configured to perform a state monitoring and control of the master device 10.

In addition, the control part 11 includes a non-transitory storage medium such as a RAM (Random Access Memory), ROM (Read Only Memory) and flash memory. The storage medium of the control part 11 stores a control program (embedded software) of the control part 11 which is mounted on the master device 10. The control program incorporates processing such as monitoring of a sensor for detecting a card medium 3, control of a drive mechanism of the card reader 1 and control of the slave device 20.

The power-down detection part 12 is a circuit which monitors voltage reduction of the main power supply 4. For example, the power-down detection part 12 includes a voltage measurement circuit which measures various voltages for the card reader 1 produced by the main power supply 4, an A/D converter and the like.

The control part 21 is a control calculation means such as a CPU, MPU, GPU, DSP or ASIC configured to perform a state monitoring and control of the slave device 20. The control part 21 executes encryption processing of information, processing of authentication utilizing encryption and the like. Specifically, the control part 21 includes, for example, an accelerator which exclusively executes hash arithmetic operations for various encryption and decryption in a system such as AES (Advanced Encryption Standard).

Further, the control part 21 includes non-transitory storage media such as a RAM, ROM, and flash memory. The storage medium of the control part 21 stores a control program (embedded software) of the control part 21. In addition, the control part 21 is capable of acquiring information of the master device 10, other configuration parts and sensors provided in the device. Further, the control program also incorporates processing such as reading and writing of a card medium 3.

More specifically, the control part 11 of the master device 10 includes a state notification part 100 and a command transmission part 110 as the function configuration parts. The control part 21 of the slave device 20 includes a state notification detection part 200 and a state processing execution part 210 as the function configuration parts. In addition, the control part 21 of the slave device 20 stores sequence information 220 in the recording medium.

The state notification part 100 notifies a state to the slave device 20 through the state notification line “B” in response to a state change. In this embodiment, this state notification is a notification of a state of voltage reduction.

The command transmission part 110 waits restoration from the state change and, when the state change is restored, the command transmission part 110 transmits a command to the slave device 20 for making the slave device 20 execute processing corresponding to the state change.

The state notification detection part 200 detects the state notification from the master device 10 through the state notification line “B”. Specifically, the state notification detection part 200 detects that a state notification has been performed when the logic of the state notification line “B” is inverted. When the state notification is detected, the state notification detection part 200 sets a notification detection flag in the sequence information 220.

When the state notification detection part 200 detects the state notification, the state processing execution part 210 waits a command from the master device 10 without immediately executing processing corresponding to the state change. In addition, in a case that the state processing execution part 210 receives the command from the master device 10 and, when the notification detection flag is set in the sequence information 220, the state processing execution part 210 performs processing corresponding to the state change. In this embodiment, the processing corresponding to the state change is processing corresponding to the voltage reduction. Specifically, when voltage reduction has been occurred in the main power supply 4, the state processing execution part 210 executes processing which clears the sequence information 220. On the other hand, in a case that the notification detection flag is not set (unsetting) in the sequence information 220, even when the state processing execution part 210 receives the command, the state processing execution part 210 does not execute processing clearing the sequence information 220 for enhancing security.

The sequence information 220 is encryption of information or encrypted information in the control part 21, various variables of the control program, a flag group and the like, and is a part of security data. The flag group includes, for example, a notification detection flag and a sequence flag. The notification detection flag is a flag which indicates that a state notification has been detected. When a state notification is detected, the notification detection flag is, for example, changed from unsetting (0) to setting (1). The sequence flag is a flag which indicates to which step encryption of information or the processing of encrypted information has advanced in the control part 21. The processing of the information includes an apparatus authentication sequence, an exchange sequence of key data utilized in the encryption processing, and the like. In addition, the sequence flag indicates that the sequence has been executed, for example, by changing from unsetting (0) to setting (1) for each step after the processing of the information was started.

In this embodiment, the control part 11 functions as the state notification part 100 and the command transmission part 110 by executing the control program stored in the built-in recording medium. The control part 21 functions as the state notification detection part 200 and the state processing execution part 210 by executing the control program stored in the built-in recording medium. Further, the respective parts of the card reader 1 described above are hardware resources for executing an information processing method in accordance with at least an embodiment of the present invention. In this case, a part or an arbitrary combination of the above-mentioned function configuration parts may be configured by using hardware such as an IC, programmable logic or FPGA (Field-Programmable Gate Array).

### State Recognition Corresponding Processing by Information Processing System “X”

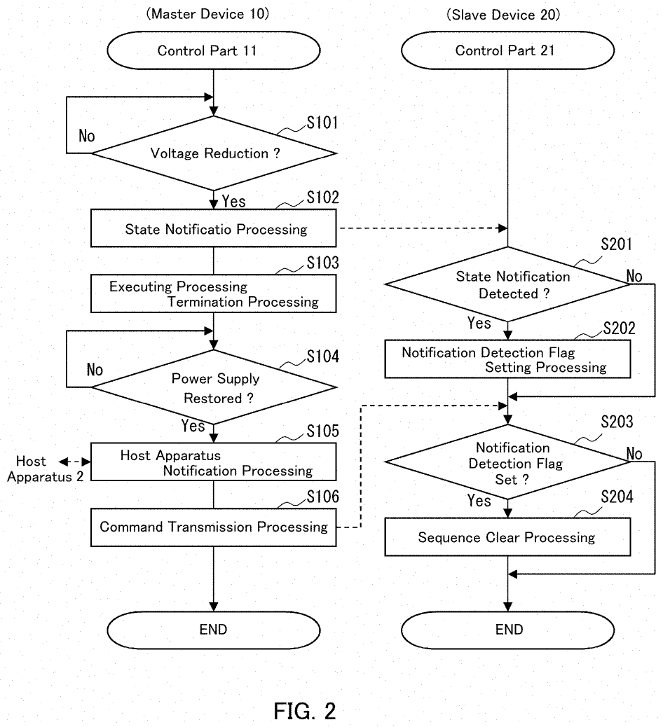

Next, state recognition corresponding processing which is executed by the card reader 1 of the information processing system “X” in accordance with at least an embodiment of the present invention will be described below with reference to FIG. 2. In the state recognition corresponding processing in this embodiment, the master device 10 performs a state notification to the slave device 20 through the state notification line “B” corresponding to a state change (change of a state). When the slave device 20 detects the state notification from the master device 10 through the state notification line “B”, the slave device 20 sets a notification detection flag. When the slave device 20 detects the state notification, the slave device 20 waits a command from the master device 10 without immediately executing processing corresponding to the state change. The master device 10 waits restoration from the state change and, when restored, the master device 10 transmits a command for executing processing corresponding to the state change to the slave device 20. When the slave device 20 receives the command and, in a case that the notification detection flag has been set, the slave device 20 executes processing corresponding to the state change and, in a case that a notification detection flag is not set, the slave device 20 does not execute processing corresponding to the state change. The state recognition corresponding processing in this embodiment is executed so that the control part 11 of the master device 10 and the control part 21 of the slave device 20 mainly execute the control programs stored in the built-in storage media and the hardware resources are used in cooperation with the respective parts. In the following descriptions, details of operation history storage processing will be described for each step with reference to the flow chart in FIG. 2.

(Step S101)

In this step, the state notification part 100 monitors voltage reduction (power down) of the main power supply 4 by the power-down detection part 12. The state notification part 100 determines “Yes” when the voltage is reduced. The state notification part 100 determines “No” in other cases. In the case of “Yes”, the state notification part 100 advances the processing to the step S102. In the case of “No”, the state notification part 100 advances the processing to the step S103.

(Step S102)

When the voltage has reduced, the state notification part 100 executes state notification processing. The state notification part 100 inverts the logic of the state notification line “B” corresponding to the state change and notifies the state to the slave device 20.

(Step S103)

Next, the state notification part 100 performs executing process termination processing. When the voltage is reduced to a predetermined value, the state notification part 100 judges that there is a possibility of a power failure (power interruption) and terminates the processing under execution (executing process) and the like adequately to prepare for power interruption. In this manner, the recording medium of the control part 11 is not damaged and a specific check is not required at a restart time and the like.

(Step S201)

Here, processing of the slave device 20 will be described below. The state notification detection part 200 determines whether a state notification is detected or not. Specifically, the state notification detection part 200 periodically monitors the state notification line “B” which is connected with the master device 10. In this embodiment, when the state notification detection part 200 detects inversion of the state notification line “B”, the state notification detection part 200 recognizes that a state notification has been detected and determines “Yes”. The state notification detection part 200 determines “No” in other cases. In the case of “Yes”, the state notification detection part 200 advances the processing to the step S202. In the case of “No”, the state notification detection part 200 advances the processing to the step S203.

(Step S202)

When the state notification is detected, the state notification detection part 200 performs notification detection flag setting processing. When inversion of the state notification line is detected, the state notification detection part 200 sets a notification detection flag of the sequence information 220. In this case, the state notification detection part 200 does not change other data of the sequence information 220. Specifically, the state notification detection part 200 does not clear, for example, a sequence flag. As a result, as described below, in a case that the master device 10 is restored from the state change, resetting of security data including the sequence information 220 is permitted in the slave device 20. In other words, in this embodiment, this processing is necessary processing when the master device 10 has recognized the state change.

(Step S104)

Here, processing of the master device 10 will be described below again. The command transmission part 110 determines whether the power supply is restored or not. The command transmission part 110 determines “Yes”, for example, in a case that, although the voltage of the main power supply 4 is reduced to a predetermined voltage, the voltage is returned to the normal voltage without further being reduced. In addition, in this embodiment, the power supply may be restored by the standby power supply 5. In this case, a power supply is supplied by the standby power supply 5 before the function of the control part 11 is stopped by power interruption. After that, even when the power supply of the main power supply 4 is interrupted, the command transmission part 110 judges that the state change is restored and determines “Yes”. In a case that the power supply remains reduced to the predetermined voltage, the command transmission part 110 determines “No”. In the case of “Yes”, the command transmission part 110 advances the processing to the step S105. In the case of “No”, the command transmission part 110 waits until the power supply is restored.

(Step S105)

When the power supply is restored, the command transmission part 110 performs host apparatus notification processing. The command transmission part 110 notifies occurrence of the voltage reduction of the main power supply 4 to the host apparatus 2 through the communication line “D”. When the host apparatus receives this notification, in a case that processing of transaction for a card medium 3 is being executed, the host apparatus 2 stops the transaction. Further, the host apparatus 2 waits restoration of the main power supply 4 and then resumes the transaction again from the beginning.

(Step S106)

Next, the command transmission part 110 performs command transmission processing. The command transmission part 110 transmits a command to the slave device 20 for making execute processing corresponding to the state change through the communication line “C”. In this embodiment, the command transmission part 110 transmits a sequence clear command for making clear the sequence information 220.

(Step S203)

Here, processing of the slave device 20 will be described below again. The state processing execution part 210 of the slave device 20 waits transmission of the command from the master device 10. In this step, when the state processing execution part 210 receives the command, the state processing execution part 210 determines whether the notification detection flag has been set in the sequence information 220 or not. When the notification detection flag has been set, the state processing execution part 210 determines “Yes”. The state processing execution part 210 determines “No” in other cases. In the case of “Yes”, the state processing execution part 210 advances the processing to the step S204. In the case of “No”, the state processing execution part 210 terminates the state recognition corresponding processing and waits detection of a state notification by the state notification detection part 200. In other words, clearing of the sequence flag or the like is not performed.

(Step S204)

In a case that the notification detection flag has been set, the state processing execution part 210 performs sequence clear processing. When the state processing execution part 210 receives the command, the state processing execution part 210 clears the sequence flag and prepares resumption of the transaction. In other words, the state processing execution part 210 waits the command from the master device 10 without immediately executing the processing corresponding to the state change and, after that, the processing is performed. In this manner, the state recognition corresponding processing in accordance with at least an embodiment of the present invention is ended.

After the voltage reduction is detected, it may be occurred that the voltage of the main power supply 4 is further reduced to become a state of complete power-off. In this case, the control part 11 performs restart processing when power is supplied next. In this restart processing, each of the master device 10 and the slave device 20 is initialized. Therefore, the sequence information 220 is also initialized.

### Specific Example of State Recognition Corresponding Processing

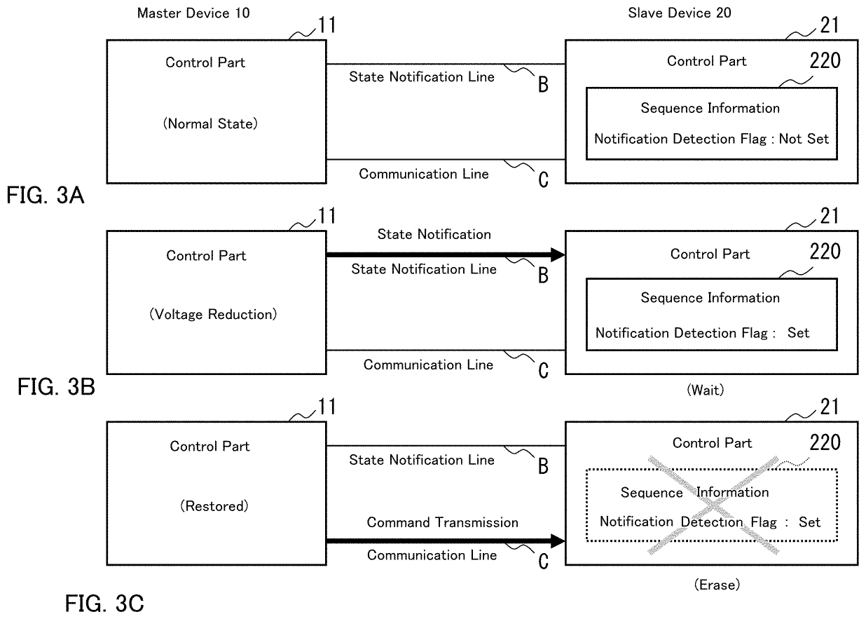

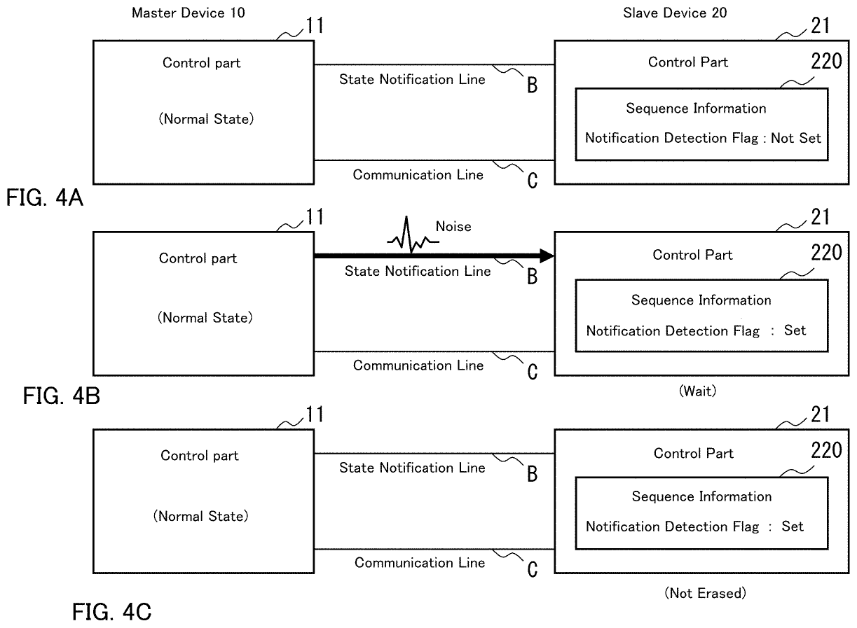

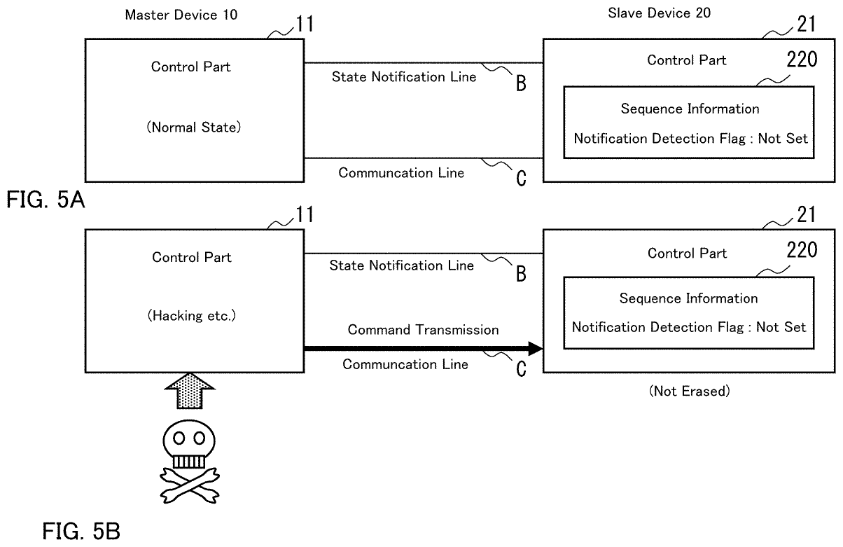

A specific example of the above-mentioned state recognition corresponding processing will be described below with reference to FIG. 3A through FIG. 3C and FIG. 4A through FIG. 4C. FIG. 3A through FIG. 3C show a case that the power supply is actually reduced, FIG. 4A through FIG. 4C show a case that the power supply is not reduced (noise), and FIG. 5A and FIG. 5B show a case that only a command is transmitted.

FIG. 3A shows an initial state. In a case that the master device 10 is in a normal state, the notification detection flag of the sequence information 220 of the slave device 20 is not set (unsetting). FIG. 3B shows an example that the master device 10 detects reduction of the voltage and performs the state notification through the state notification line “B”. When the slave device 20 detects the inversion of the state notification line “B”, the slave device 20 sets a notification detection flag. The slave device 20 waits as it is until the slave device 20 receives a command. FIG. 3C shows an example that the slave device 20 has received the command transmitted through the communication line “C”. In this case, the notification detection flag has been set and thus, the sequence information 220 is cleared (erased).

FIG. 4A shows the initial state which is the same as FIG. 3A. FIG. 4B shows a case that, although the master device 10 is in the normal state, the logic of the state notification line “B” is inverted due to noise or the like. Also in this case, when the slave device 20 detects the inversion of the state notification line “B”, the slave device 20 sets a notification detection flag. FIG. 4C shows an example that a command is not transmitted because the master device 10 is normal. In this case, although the notification detection flag has been set, a command is not received. Therefore, the processing at the time of power supply restoration is not executed and thus, the sequence information 220 is not erased. In this state, in a case that power interruption due to voltage reduction is occurred and then restarted, the sequence information 220 in itself including the notification detection flag and the sequence flag is initialized.

FIG. 5A shows the initial state which is the same as those in FIG. 3A and FIG. 4A. FIG. 5B shows an example that an illegal operation has been performed on the card reader 1 or the information processing system “X” and a command is transmitted in a state that the notification detection flag of the sequence information 220 is not set. In this case, the sequence information 220 is not erased. In other words, execution of a sequence clear command is restricted by a notification detection flag. Since the command is unable to be executed in cases except the voltage reduction, the security can be enhanced.

### Principal Effects in this Embodiment

The embodiment of the present invention is structured as described above and thus, the following effects can be obtained. Conventionally, a technique has been known in which, when a state of the master device 10 is to be notified to the slave device 20 between the master device 10 and the slave device 20, a state notification command is transmitted from the master device 10 through a communication line connecting the master device 10 with the slave device 20 and the slave device 20 receives the command, and a change of the state (state change) of the master device 10 is recognized. In such a system, for example, when the master device 10 is going to transmit a state notification command for notifying a state change to the slave device 20, it may be occurred that communication by the master device 10 becomes unstable due to the state change and thereby, the communication is unable to be performed normally. In this case, the state change of the master device 10 is unable to be notified to the slave device 20. In such a situation, it may be occurred that the processing cannot be performed well when restored from the state change.

On the other hand, the card reader 1 in accordance with at least an embodiment of the present invention is an information processing device in which the master device 10 and the slave device 20 are capable of communicating with each other. The state notification line “B” for notifying a state of the master device 10 and the communication line “C” for transmitting and receiving a command and data are connected between the master device 10 and the slave device 20. The master device 10 includes the state notification part 100 configured to perform a state notification to the slave device 20 through the state notification line “B” corresponding to a state change, and the command transmission part 110 configured to wait restoration from the state change and, when restored, transmit a command to the slave device 20 for executing processing corresponding to the state change through the communication line “C”. The slave device 20 includes the state notification detection part 200 configured to set a notification detection flag when the state notification from the master device 10 is detected through the state notification line “B”, and the state processing execution part 210 configured to wait the command from the master device 10 without immediately executing the processing corresponding to the state change when the state notification detection part 200 detects the state notification and, when the state processing execution part 210 receives the command, the state processing execution part 210 performing the processing corresponding to the state change in a case that the notification detection flag has been set and, in a case that the notification detection flag is not set, the processing corresponding to the state change is not performed. According to this structure, even when a state change is occurred, the state notification line which is capable of surely transmitting information is always monitored and a notification detection flag is set and thus, the processing after restoration can be secured. In other words, when restored from the state change, in a case that the master device 10 instructs the slave device 20 so as to perform processing corresponding to the state change, since the notification detection flag is set, the processing when restored can be surely executed.

In this case, as described above, it is conceivable to configure so that the state notification line “B” is connected and, when an object state of the master device 10 is changed, the change of the state (state change) is notified to the slave device 20 by inverting a logic of the notification line, and the slave device 20 monitors the notification line periodically and, when a change of the notification line is received, the slave device 20 recognizes the state change of the master device 10. However, when it is configured that the processing corresponding to the state change is performed only with the state notification line “B”, as shown in FIG. 4B, in a case that the logic of the notification line is inverted due to noise entering into the notification line, the slave device 20 may erroneously recognizes the state change. As a measure for the noise, for example, it is conceivable to configure so that, even when the logic of the signal line is inverted, without immediately recognizing that the state has been changed, the change is recognized only when the change is continued over a certain predetermined time period during later monitoring of the signal line. However, even in the configuration described above, the configuration is unable to cope with continuous noise exceeding a certain time period and thus, the measure has a limit. On the other hand, the card reader 1 in this embodiment is capable of preventing false recognition of the state change caused by inversion of the state notification line due to noise by instructing actual processing start through a command. Therefore, processing for the state change can be executed surely.

In the card reader 1 in accordance with at least an embodiment of the present invention, the master device 10 is a main processing device which performs monitoring of a state of a detection sensor for a card medium 3 and controls various drive mechanisms, and the slave device 20 is a sub-processing device in which encryption of information is executed, encrypted information is processed, and writing and reading of information for the card medium 3 are controlled. According to this structure, in the slave device 20 which is required to observe a specific processing procedure for performing encryption processing, when a state change is occurred, processing corresponding to this state change can be surely executed while preventing malfunction due to noise or the like. As a result, the slave device 20 does not become an error at the time of restoration from the state change and thus, a restart or the like is not required, labor of service can be reduced, and a maintenance cost can be reduced.

Further, as described above, in a case that a voltage of the power supply is only reduced to a predetermined value, the functions of both the control part 11 and the control part 21 are not stopped, and various variables and flags of the control program operated inside are held. Therefore, in a case that the sequence flag and the like are left in a middle state of the last transaction, when the voltage of the power supply is restored and the transaction is resumed, it is determined that the sequence is abnormal and the processing is unable to be advanced. On the other hand, in the card reader 1 in accordance with at least an embodiment of the present invention, a state notification is a notification of a state with respect to voltage reduction and, when the voltage is reduced, the state processing execution part 210 executes processing which clears a sequence of information processing. According to this structure, when voltage reduction occurs, transaction resumption after the main power supply 4 is restored is forecast and the sequence flag can be cleared.

Further, when inversion of the state notification line “B” is detected, if it is immediately determined that a power-down is occurred and the sequence information 220 is cleared, inconvenience may be occurred. In other words, even in a case that the logic of the state notification line is inverted due to noise, when the sequence information 220 in the middle of execution is cleared, an error occurs due to inconsistency of the sequence. On the other hand, in the card reader 1 in accordance with at least an embodiment of the present invention, a notification detection flag is set when inversion of the state notification line “B” is detected without immediately clearing a sequence flag and, when the state of the main power supply 4 is restored, the control part 11 transmits a sequence clear command to the control part 21. According to this structure, when the power supply is restored, the sequence information 220 is cleared after receiving a command and transaction resumption can be prepared. In other words, even if the inversion of the notification line “B” is caused by noise, the notification detection flag is set. However, after that, processing at the time of restoration of the main power supply is not executed and thus, the sequence information 220 is not cleared. As a result, an error due to noise or the like can be prevented. Further, in the card reader 1 in this embodiment, in a case that the state change does not occur by the notification detection flag, the sequence flag clear command is not executed. Therefore, security can be enhanced.

In the card reader 1 in accordance with at least an embodiment of the present invention, the information processing device is a card reader. According to this structure, a card reader can be provided in which processing corresponding to the state change can be surely executed and an error does not occur in the processing performed when the state change such as voltage reduction is restored. Therefore, a maintenance cost can be reduced.

### Other Embodiments

In the embodiment described above, an output of the state notification line “B” is an output from the control part 11. However, an output of the state notification line “B” may be a direct output which is directly outputted from a circuit board of the master device 10. In addition, for example, an output from a power failure detection signal may be used as an output of the state notification line “B”. According to this structure, even when a state change is not temporarily detected by the control part 11, the state can be notified to the slave device 20. Also in this case, the master device 10 may also acquire an output of the state notification line “B” and detects an illegal operation.

In addition, it may be structured that the state notification line “B” in itself does not use a physical conducting wire, and that the state is notified through a pair of a light emitting part and a light receiving part of an optical sensor, an electrostatic capacitance sensor or the like. Further, an arbitrary communication system may be used for the communication line “C”. For example, the UART, I2C or USB may be utilized. According to this structure, it can be adaptable to a flexible configuration.

In the embodiment described above, voltage reduction is detected as a state change, but the present invention is not limited to this embodiment. For example, a state change may be applied to a detection of a state change such as “DSR Off” of the communication line “D” with the host apparatus 2. In addition, a state change may be applied to various state notifications such as completion of magnetic reading and completion of encryption processing. According to this structure, processing corresponding to the state change is surely executed in the slave device 20 while preventing malfunction due to noise and an error can be avoided.

In the embodiment described above, as an example, the master device 10 and the slave device 20 are structured as the card reader 1. However, an information processing system “X” (information processing device) in which the host apparatus 2 is the master device 10 and the card reader 1 is the slave device 20 may be configured so as to execute the respective processings in the embodiment described above. In this case, it may be structured that the state notification line is connected with the host apparatus 2 and the card reader 1 and a command is transmitted and received by using the communication line “D”.

In addition, in the embodiment described above, the card reader 1 executes the above-mentioned various processings. However, at least an embodiment of the present invention may be applied to an information processing device which is capable of communicating between the master device 10 and the slave device 20 other than the card reader.

Although the present invention has been shown and described with reference to a specific embodiment, various changes and modifications will be apparent to those skilled in the art from the teachings herein.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An information processing device comprising:
a master device and a slave device structured to communicate with each other;
a state notification line connected between the master device and the slave device being structured to perform a state notification of the master device; and
a communication line connected between the master device and the slave device structured to transmit and receive a command and data;
wherein the master device comprises:
a state notification part structured to perform the state notification to the slave device through the state notification line corresponding to a state change; and
a command transmission part structured to await restoration of the state change and, when the state change is restored, transmit the command to the slave device for making execute processing corresponding to the state change through the communication line; and
wherein the slave device comprises:
a state notification detection part structured to set a notification detection flag when the state notification detection part detects the state notification from the master device through the state notification line; and
a state processing execution part structured to await the command from the master device without immediately executing processing corresponding to the state change when the state notification detection part detects the state notification and, when the state processing execution part receives the command, in a case that the notification detection flag has been set, the state processing execution part is structured to perform the processing corresponding to the state change and, in a case that the notification detection flag has not been set, the state processing execution part does not perform the processing corresponding to the state change.

2. The information processing device according to claim 1, wherein
the master device is a main processing device structured to monitor a state of a card medium detection sensor and controls various drive mechanisms, and
the slave device is a sub-processing device structured to execute encryption of information, processes encrypted information, and controls writing and reading of information to and from a card medium.

3. The information processing device according to claim 1, wherein
the state notification is a notification of the state of voltage reduction, and
when the voltage reduction is occurred, the state processing execution part is structured to execute processing which clears a sequence of processing of information.

4. The information processing device according to claim 1, wherein the information processing device is a card reader.

5. An information processing method executed by an information processing device which comprises a master device and a slave device which are capable of communicating with each other, a state notification line connected between the master device and the slave device for performing a state notification of the master device, and a communication line connected between the master device and the slave device for transmitting and receiving a command and data, the information processing method comprising:
performing the state notification by the master device to the slave device through the state notification line corresponding to a state change;
setting a notification detection flag by the slave device when the slave device detects the state notification from the master device through the state notification line;
waiting the command from the master device without immediately executing processing corresponding to the state change when the state notification is detected by the slave device;
waiting restoration from the state change in the master device and, when the state change is restored, transmitting the command by the master device to the slave device for making execute processing corresponding to the state change; and
when the slave device receives the command, in a case that the notification detection flag has been set, the processing corresponding to the state change is performed and, in a case that the notification detection flag is not set, the processing corresponding to the state change is not performed.

6. The information processing device according to claim 2, wherein
the state notification is a notification of the state of voltage reduction, and
when the voltage reduction is occurred, the state processing execution part executes processing which clears a sequence of processing of the information.

7. The information processing device according to claim 2, wherein the information processing device is a card reader.

8. The information processing device according to claim 3, wherein the information processing device is a card reader.

9. The information processing device according to claim 6, wherein the information processing device is a card reader.
